(19) United States
(12) Patent Application Publication
(10) Pub. No.: US 2026/0138617 A1
(43) Pub. Date: May 21, 2026

(54) IDENTIFYING TRANSIENT DISCOORDINATION BETWEEN PHYSIOLOGICAL RESPONSES

(71) Applicant: Toyota Motor Engineering & Manufacturing North America, Inc., Plano, TX (US)

(72) Inventors: Hossein Hamidi Shishavan, Westland, MI (US); Paul D. Schmalenberg, Ann Arbor, MI (US)

(21) Appl. No.: 18/955,304

(22) Filed: Nov. 21, 2024

(51) Int. Cl. B60W 40/08

(52) U.S. Cl. CPC B60W 40/08; B60W 2040/0827; B60W 2540/22

(57) ABSTRACT

Systems, methods, and other embodiments described herein relate to identifying transient discoordination within a person. In one embodiment, a method includes acquiring sensor data that characterizes a current condition of a person. The method includes extracting feature instances from the sensor data that correspond with the current condition. The method includes identifying transient discoordination in the person according to the feature instances. The method includes providing an indicator of the transient discoordination.

### TECHNICAL FIELD

The subject matter described herein relates, in general, to identifying transient discoordination within a person and, more particularly, to processing biosignals of a person using a unique manner of analysis to extract and segment features from the biosignals to facilitate identifying the transient discoordination.

### BACKGROUND

The human organism generally operates synchronously. Functions of the human body can be monitored using physiological signals from sensors attached to the body or that are otherwise able to observe a current condition thereof. However, disruptions, whether internal or due to external stimuli, can lead to a state of asynchrony or discoordination within physiological responses. This asynchrony and interaction between responses can be studied to identify the underlying cause, which may be linked to various factors such as intoxication, fatigue, drowsiness, etc. Analyzing the data to identify these occurrences represents a significant challenge. That is, trying to understand the underlying mechanisms and their interactions amongst different signals, and extracting meaningful parameters that are usable for diagnostics and risk stratification is a non-trivial task.

Despite various approaches for analyzing time-series data, no single method is best suited to characterize interactions between physiological systems. For example, these signals are often affected by artifacts such as motion artifacts, subconscious biological changes, etc. Consequently, traditional scoring techniques for long time-series data can be misleading due to the abundance of intertwined information and artifacts. As such, identifying asynchrony within the biosignals is a complex task that may encounter various difficulties.

### SUMMARY

Example systems and methods relate to a manner of identifying transient discoordination within a person. As previously noted, analyzing biosignals of a person may permit the identification of various conditions. However, there are many different biosignals that are available and each separate biosignal can include many different points of information to analyze that may be mixed with other signals and various aberrations. As such, analyzing this information to extract meaningful information can be an elusive task. That is, identifying salient features within the time-series data embodied as the biosignals is difficult when considering the multiplicity of factors that can influence changes in the biosignals.

Therefore, in at least one arrangement, an inventive system is disclosed that functions to identify transient discoordination within a person using a unique approach. For example, the inventive system initially acquires sensor data about a person that is to be analyzed for a condition. The condition may vary but generally includes conditions, such as drowsiness, intoxication, fatigue, and so on. The sensor data may also vary in form but is generally comprised of biosignals that are time-series data and can include ECG signals, EDA signals, temperature, glucose levels, and so on.

The system processes the data to extract features such as, for example, heart rate from ECG, tonic and phase components from EDA, alpha wave activity from EEG, and so on. Extracting the features from the biosignals provides many different markers that may correspond with the discoordination the system is attempting to identify. However, at the same time, not all of the markers may correlate with a particular condition that is to be monitored, some of the markers may be redundant, which can skew the determination, and other features may include missing values or exhibit low variance, which are generally undesirable. Thus, the system performs feature selection in order to select relevant features from the extracted features so as to limit the processing to features that are more likely to exhibit a correlation with the monitored condition(s) without, for example, exhibiting various aberrations.

Once the system selects the relevant features, the system performs data segmentation to discretize the features into feature instances. The process of segmentation considers each relevant feature individually in order to identify the quantity and positions of indices for the feature instances. After segmenting the relevant features, the system can then cluster the feature instances into groups. The clustering generally functions to organize different data points according to their similarity, which may include a metric such as distance, correlation, Dynamic Time Warping (DTW), etc. In general, the clustering separates common occurrences of the relevant features from instances associated with stimuli that may be internal and/or external. Once clustered, the system can then filter the instances to correlate the anomalous instances with stimuli, such as, for example, stress or other emotional events. Thereafter, the system can further process the filtered instance data to derive additional information, such as the intensity of an occurrence of transient discoordination. In any case, the system is able to identify the transient discoordination from the filtered data as the anomalies (i.e., distinct instances that vary from the baseline). The system can use this information to generate alerts and/or to separately train a model on identifying the transient discoordination from the input biosignals. In this way, the present system is able to identify salient aspects of the biosignals and thereby identify the occurrence of various conditions in the person to facilitate additional functions, such as alerts to drivers, health reminders, and so on.

In one embodiment, a correlation system is disclosed. The correlation system includes one or more processors and a memory communicably coupled to the one or more processors. The memory stores instructions that, when executed by the one or more processors, cause the one or more processors to acquire sensor data that characterizes a current condition of a person. The instructions include instructions to extract feature instances from the sensor data that correspond with the current condition. The instructions include instructions to identify transient discoordination in the person according to the feature instances. The instructions include instructions to provide an indicator of the transient discoordination.

In one embodiment, a non-transitory computer-readable medium including instructions that, when executed by one or more processors, cause the one or more processors to perform one or more functions is disclosed. The instructions include instructions to acquire sensor data that characterizes a current condition of a person. The instructions include instructions to extract feature instances from the sensor data that correspond with the current condition. The instructions include instructions to identify transient discoordination in the person according to the feature instances. The instructions include instructions to provide an indicator of the transient discoordination.

In one embodiment, a method is disclosed. In one embodiment, the method includes acquiring sensor data that characterizes a current condition of a person. The method includes extracting feature instances from the sensor data that correspond with the current condition. The method includes identifying transient discoordination in the person according to the feature instances. The method includes providing an indicator of the transient discoordination.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIG. 1 illustrates one embodiment of a correlation system that is associated with identifying transient discoordination within a person.

FIG. 2 illustrates one embodiment of the correlation system of FIG. 1 implemented within a vehicle.

FIG. 3 illustrates one embodiment of the correlation system of FIG. 1 in a cloud-computing environment.

FIG. 4 illustrates a flowchart for one embodiment of a method that is associated with analyzing sensor data to identify occurrences of transient discoordination.

FIG. 5 illustrates an example process flow associated with generating data to train a model by labeling the data according to occurrences of transient discoordination.

FIG. 6 illustrates an example of time-series data in relation to separate steps of a disclosed approach.

FIG. 7 illustrates a further example of time-series data and the correlation of different features.

FIG. 8 illustrates one embodiment of using a neural network to classify sensor data.

### DETAILED DESCRIPTION

Systems, methods, and other embodiments associated with identifying transient discoordination within a person are disclosed. As previously noted, analyzing biosignals of a person may permit the identification of various conditions. However, biosignals are complex time-series-based data that include many different features, which may be combined together in a single signal, along with various aberrations that can complicate analysis. As such, analyzing this information to extract meaningful information can be an elusive task. That is, identifying salient features within the time-series data embodied as the biosignals is difficult when considering the multiplicity of factors that can influence changes in the biosignals.

Therefore, in at least one arrangement, an inventive system is disclosed that functions to identify transient discoordination within a person using a unique approach. In general, the system may function to identify the transient discoordination as a way to identify the occurrence of various conditions related to a person. For example, the system may identify the occurrence of drowsiness, fatigue, stress, or other health-related occurrences in a person, which can then facilitate improving a response to the person in various contexts, such as driving. It should be noted that while various short-term determinations are highlighted, the system can further provide long-term monitoring to identify progressive diseases in individuals. The inventive system initially acquires sensor data about a person that is to be analyzed for a condition. The sensor data may vary in form but is generally comprised of biosignals, which may be invasive or non-invasive measurements, that are time-series data and can include ECG signals, EDA signals, temperature, glucose levels, and so on.

The system processes the data to extract features such as, for example, heart rate from ECG, tonic and phase components from EDA, alpha wave activity from EEG, and so on. Extracting the features from the biosignals provides many different markers that may correspond with the discoordination the system is attempting to identify. However, at the same time, not all of the markers may correlate with a particular condition that is to be monitored, some of the markers may be redundant, which can skew the determination, and other features may include missing values or exhibit low variance, which are generally undesirable. Thus, the system performs feature selection in order to select relevant features from the extracted features so as to limit the processing to features that are more likely to exhibit a correlation with the monitored condition(s) without, for example, exhibiting various aberrations.

Once the system selects the relevant features, the system performs data segmentation to discretize the features into feature instances. The process of segmentation considers each relevant feature individually in order to identify the quantity and positions of indices for the feature instances. The segmentation can be based on changes in underlying feature data points, such as gradual or sudden shifts in signal parameters like mean, standard deviation, etc. After segmenting the relevant features, the system can then cluster the feature instances into groups. The clustering generally functions to organize different data points according to their similarity. In general, the clustering separates common occurrences of the relevant features from instances associated with stimuli. Once clustered, the system can then filter the instances to correlate the anomalous instances with stimuli, such as, for example, stress or other emotional events. Thereafter, the system can further process the filtered instance data to derive additional information, such as the intensity of an occurrence of transient discoordination. In any case, the system is able to identify the transient discoordination from the filtered data as the anomalies (i.e., distinct instances that vary from the baseline). The system can use this information to generate alerts and/or to separately train a model on identifying the transient discoordination from the input biosignals. In this way, the present system is able to identify salient aspects of the biosignals and thereby identify the occurrence of various conditions in the person to facilitate additional functions, such as alerts to drivers, health reminders, and so on.

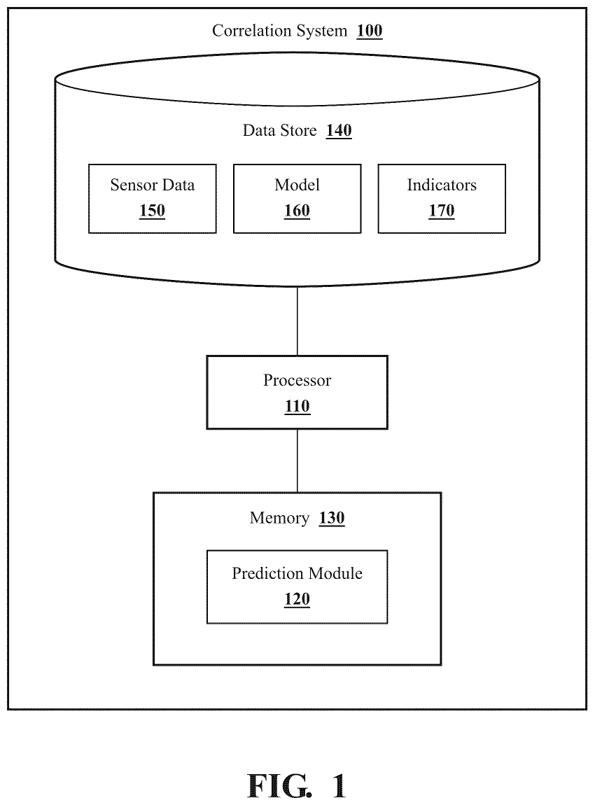

With further reference to FIG. 1, one embodiment of the correlation system 100 is further illustrated. The correlation system 100 is shown as including a processor 110. Accordingly, the processor 110 may be a part of the correlation system 100, or the correlation system 100 may access the processor 110 through a data bus or another communication path. In one or more embodiments, the processor 110 is an application-specific integrated circuit (ASIC) that is configured to implement functions associated with a prediction module 120. In general, the processor 110 is an electronic processor, such as a microprocessor that is capable of performing various functions as described herein. In one embodiment, the correlation system 100 includes a memory 130 that stores the prediction module 120 and/or other modules that may function in support of generating depth information. The memory 130 is a random-access memory (RAM), read-only memory (ROM), a hard disk drive, a flash memory, or other suitable memory for storing the prediction module 120. The prediction module 120 is, for example, computer-readable instructions that, when executed by the processor 110, cause the processor 110 to perform the various functions disclosed herein. In further arrangements, the prediction module 120 is a logic, integrated circuit, or another device for performing the noted functions that includes the instructions integrated therein.

Furthermore, in one embodiment, the correlation system 100 includes a data store 140. The data store 140 is, in one arrangement, an electronic data structure stored in the memory 130 or another electronic medium, and that is configured with routines that can be executed by the processor 110 for analyzing stored data, providing stored data, organizing stored data, and so on. Thus, in one embodiment, the data store 140 stores data used by the prediction module 120 in executing various functions. For example, as depicted in FIG. 1, the data store 140 includes the sensor data 150, models 160 that are, in at least one approach, machine-learning models, and indicators 170, along with, for example, other information that is used and/or produced by the prediction module 120. While the correlation system 100 is illustrated as including the various elements, it should be appreciated that one or more of the illustrated elements may not be included within the data store 140 in various implementations. In any case, the correlation system 100 stores various data elements in the data store 140 to support functions of the prediction module 120.

Continuing with the highlighted data elements, the sensor data 150 includes, for example, one or more biosignals about a person that is being monitored. The biosignals generally characterize a current condition of a person in relation to an emotional state, overall health, the occurrence of acute conditions, long-term chronic conditions, and so on. Moreover, the sensor data 150, in at least one arrangement, also includes previous observations of a person as the sensor data 150 can provide continuous measurements over a period of time. The biosignals are time series data, i.e., data collected over a period of time that is generally, for example, continuous, although some biosignals may include aberrations that result in missing segments. In any case, the sensor data 150 can include, by way of example, electrocardiogram (ECG), electrodermal activity (EDA), respiration, temperature, blood glucose level, electroencephalogram (EEG), electrocardiogram (EKG), blood pressure, blood oxygen, and/or other biosignals that provide information about the current condition of the person. It should be noted that the above listing is provided for purposes of discussion and should not be construed as limiting the biosignals that the correlation system 100 may process.

The correlation system 100 functions to collect the sensor data 150 from various sensors associated with the correlation system 100. That is, the sensors may be a part of the correlations system 100 or the correlation system 100 may otherwise access the sensor data 150 from the sensors via a communication link directly to the sensors or to a repository of the sensor data 150 provided by the sensors. In any case, the correlation system 100 leverages the sensors to acquire the sensor data 150. In various arrangements, the sensors may be comprised of a single sensor or multiple sensors. The sensors may be of a single type or of different types to capture the different biosignals. Moreover, the sensors may include biophysical sensors, biochemical sensors, image sensors, and so on. By way of example, the sensors can include EKG/ECG sensors (e.g., knitted integrated sensors (KIS), wet electrode sensors, etc.), a skin conductance sensor for EDA, EEG sensor array, blood pressure cuff, pulse oximeter, continuous glucose monitor, and so on. The sensors may be embedded within components of a passenger compartment of a vehicle, a seat within a vehicle, a steering wheel, and so on. Additionally, in one or more arrangements, a person may wear one or more sensors that communicate the sensor data 150 or at least a portion thereof to the correlation system 100.

While biosignal-specific sensors are listed, it should be appreciated that general-use sensors, such as cameras (e.g., visible light, infrared, etc.) can also be used to acquire the biosignals. For example, the prediction module 120 can acquire camera images of a person and then process the images using various models or heuristics to derive biosignals, such as heart rate, respiration rate, heart rate variability (HRV), and so on. It should be appreciated that other sensors may also be used in isolation or in combination with the camera, such as radar (e.g., mmWave radar), etc.).

Continuing with elements shown in the data store 140, the models 160 are, in one arrangement, machine-learning models and/or other algorithms. In one arrangement, the models 160 include a model to identify the current condition of the person according to the biosignals or, in one arrangement, features extracted from the biosignals. In any case, the model is, for example, a machine-learning algorithm, such as a neural network. The neural network may be a deep neural network (DNN), a recurrent neural network (RNN), a transformer-based network, or another type of neural network for processing the noted data into a determination about transient discoordination in the person. In further arrangements, the models 160 may include one or more statistical models, clustering algorithms, segmenting algorithms, and/or other algorithms that support the correlation system 100 in extracting, segmenting, and analyzing the information from the biosignals.

In any case, FIG. 1 further illustrates the data store 140 as, including the indicators 170. The indicators 170, in at least one configuration, include determinations by the prediction module 120 about the sensor data 150. That is, for example, the indicators 170 specify results of processing the sensor data 150. Thus, in at least one approach, the indicators 170 include identifiers of a condition identified by the prediction module 120, such as drowsiness, stressed, intoxicated, etc. In further arrangements, the prediction module 120 may also generate an indication of the intensity of the event/condition as part of the indicators 170. As such, the indicators can specify the type of the current condition and also a severity/intensity, which may be provided on a scale that is specific to the condition.

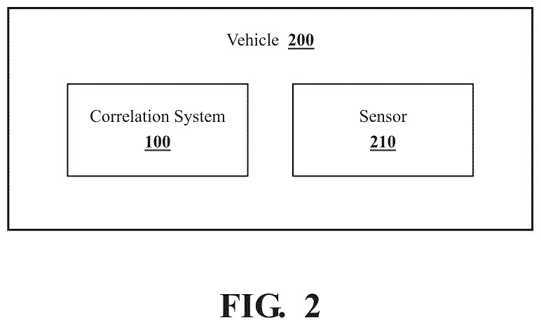

With reference to FIG. 2, one implementation of the correlation system 100 is illustrated. As shown in FIG. 2, a vehicle 200 includes the correlation system 100 that is implemented in combination with a sensor 210. The sensor 210 may be a camera or biosignal-specific sensor. In any case, the sensor 210 collects the sensor data 150 about at least one person that is present within the vehicle 200. Thus, as outlined further subsequently, the correlation system 100 acquires the sensor data 150 from the sensor 210 and analyzes the sensor data 150 to identify the occurrence of transient discoordination in the included biosignal(s). When present and depending on the particular form of the transient discoordination (i.e., in which biosignal, an intensity, etc.), the correlation system 100 can then adapt operation of the vehicle 200 to account for the occurrence. The form of the adaptation may vary widely depending on the type of the discoordination event but can include generating a message/alert to the driver, controlling navigation of the vehicle 200, and so on.

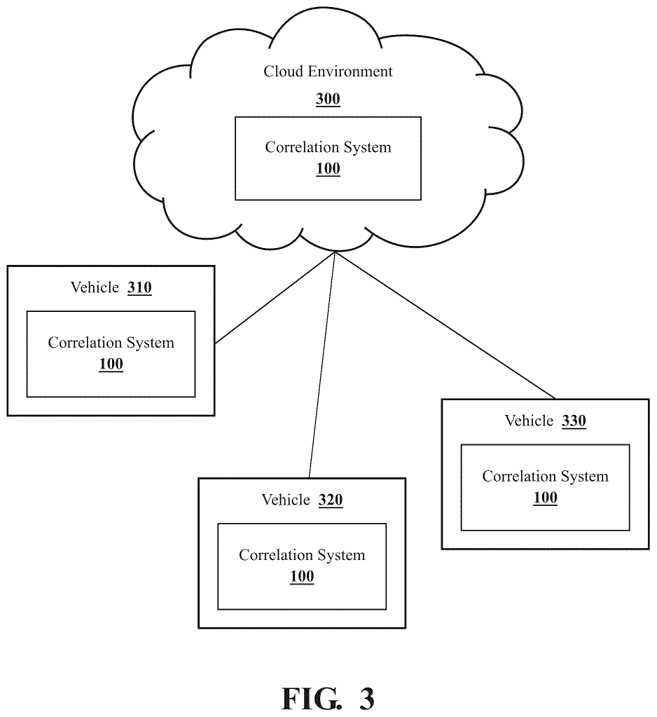

A further embodiment of the correlation system 100 is illustrated in FIG. 3. As previously noted, the correlation system 100 may be further implemented within, for example, a cloud-based system that functions within a cloud environment 300, as illustrated in relation to FIG. 3. As shown, the correlation system 100 may acquire data (e.g., sensor data 150) from client instances within the vehicles 310, 320, and 330 and perform analysis at a remote server that is integrated as part of the cloud environment 300. Accordingly, the instances of the correlation system 100 within the vehicles 310, 320, and 330 communicate wirelessly with the cloud-environment 300 via a cellular network (e.g., Frequency-Division Multiple Access (FDMA), Code-Division Multiple Access (CDMA), etc.), a peer-to-peer (P2P) based network, WiFi, DSRC, V2I, V2V, or according to another communication protocol that is capable of conveying the sensor data 150 to the cloud and the indicators 170 back to the respective vehicle.

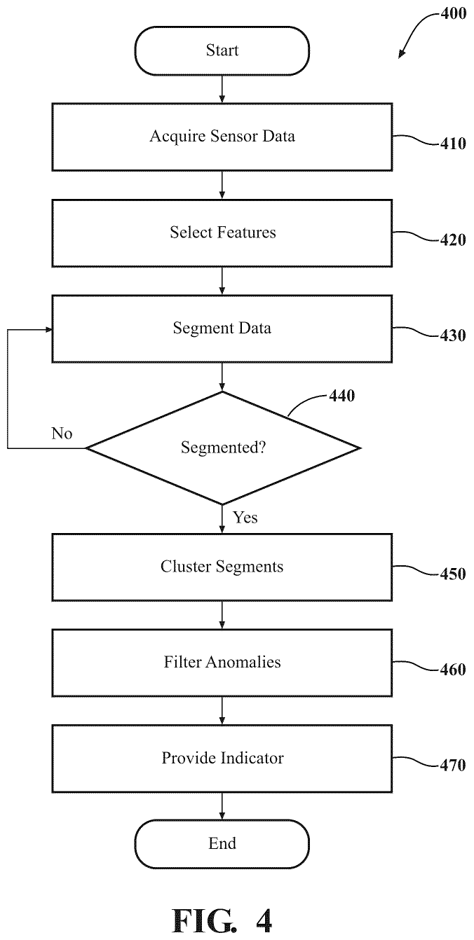

Additional aspects of identifying transient discoordination will be discussed in relation to FIG. 4. FIG. 4 illustrates a flowchart of a method 400 that is associated with identifying the occurrence of transient discoordination in a person in order to determine an associated current condition and provide mitigating actions. Method 400 will be discussed from the perspective of the correlation system 100 of FIG. 1. While method 400 is discussed in combination with the correlation system 100, it should be appreciated that the method 400 is not limited to being implemented within the correlation system 100 but is instead one example of a system that may implement the method 400.

At 410, the prediction module 120 acquires the sensor data 150. As indicated previously, the sensor data 150 includes biosignals about the current condition of a person. It should be appreciated that a current condition of the person may be reflected in the sensor data 150 as collected over a period of time that may be minutes, hours, days, months, etc. In general, the prediction module 120 may collect the sensor data 150 in a substantially continuous manner over a defined period that may be a sliding window, or simply a known history of the person. As previously outlined, the sensor data 150 can be acquired from various different types of sensors in different configurations. In general, the sensor data 150 characterizes a current condition of the person, which may relate to a physiological or mental state.

Thus, the correlation system 100 generally includes an operable communication link with the sensors to acquire the sensor data 150. The correlation system 100 may actively acquire the sensor data 150 via direct communication with the sensors worn by or proximate to the person or may acquire the sensor data 150 by sniffing the signals from communications on a communication bus or other network associated with the sensors. In any case, the prediction module 120 acquires the sensor data 150 in an iterative manner in order to monitor a current condition of the person. Moreover, as part of acquiring the sensor data 150, the prediction module 120, in at least one configuration, preprocesses the sensor data 150. Preprocessing may involve removing motion artifacts by applying one or more filtering techniques (e.g., low/high-pass filters, adaptive filters, wavelet transform, etc.). In general, the correlation system 100 may preprocess the sensor data 150 to make sensor data 150 more reliable due to, for example, missing elements or if the sensor data 150 is distorted from noise.

At 420-440, the prediction module 120 extracts features from the sensor data 150. As outlined herein, the process of extracting the features can involve multiple separate steps. For example, at 420, the prediction module 120 initially extracts features from the sensor data 150 using signal processing techniques. The features are explicit characteristics embodied within the sensor data, such as heart rate in an ECG, tonic, and phase components of an EDA signal, alpha wave activity of EEG, and so on. Thus, the prediction module 120 applies signal processing techniques to extract the features, which can include Fourier transforms to analyze frequency components of the biosignals, power spectral density (PSD) analysis to quantity the distribution of power into frequency components, time-domain statistical measures (e.g., mean, standard deviation, root mean square (RMS), and entropy), and so on.

After the features are extracted, the prediction module 120 further assesses the extracted features to select relevant features and discard features that are ancillary, not indicative of the current condition, and so on. For example, the prediction module 120 can assess the extracted features for low variance, which involves removing features that do not change within a minimum range across samples. As a further example, the prediction module 120 can remove features that are highly correlated with each other (e.g., redundant features) to retain one of a group. Similarly, the prediction module 120 can remove duplicative features from separate biosignals (e.g., heart rate from ECG and PPG). Additionally, the prediction module 120 may further remove features with missing values, such as features that have a percentage of information over a threshold (e.g., >30%) that is unavailable. In this way, the prediction module 120 is able to select relevant features from the extracted features to focus the subsequent analysis.

At 430, the prediction module 120 proceeds with processing the relevant features by segmenting the relevant features into feature instances. The feature instances are discrete occurrences of the features within the biosignals. That is, because the biosignals are generally continuous signals, there is no inherent segmentation between each separate occurrence of a feature. That is, for example, an ECG encodes a heart rate as a continuous signal of the electrical activity of the heart in which the heart rate is present but not explicitly discretized. As such, the prediction module 120 discretizes the relevant features within the biosignals to distinguish between the relevant features over the time-series.

Consider the following approach as one example of how the prediction module 120 may segment the relevant features into feature instances. In general, the process of segmenting, as implemented by the prediction module 120, in one configuration, involves detecting changes in top-level metrics. In various approaches, the segmentation may involve nonparametric techniques. The prediction module 120 considers each feature in a probabilistic time series with the sequence of random variables from subset space (x∈X), denoted as xᵢ, i=0, . . . , n. “n” represents data at each time step. The approach assumes that some characteristics of xᵢ changes abruptly at the unknown instances. Thus, the prediction module 120, in one approach, has a goal to partition the vector into K contiguous sub-sequences as a function of the abrupt changes. The partitions, which are represented as (τ=τ₁, τ₂, . . . , τₖ₋₁) allow the prediction module 120 to examine each segment for distinct statistical characteristics. The feature vector for the partitions is represented as: X={{x₀, . . . , x_{τ}_{₁}}, . . . , {x_{τ}_{ₖ₋₂}, . . . , x_{τ}_{ₖ₋₁}}}.

Each data segment is labeled as S={S₁, . . . , Sₖ}. Thus, the feature is segmented based on indices in t and then named using the “S” label. The objective is to identify both the quantity and positions of these indices. By way of example, the correlation system 100 can apply segmentation using a penalized contrasts method, which involves detecting abrupt shifts in the time-series parameters (e.g., mean, variance, distribution, and/or certain quantiles). In this approach, the correlation system 100 estimates both the number of changes and locations in time of the changes. In other words, the correlation system 100 assesses the effectiveness for different ways of segmenting and also balances the effectiveness against the complexity (i.e., more segments result in greater complexity). The correlation system 100 can define the penalized contrast equation as follows: J(τ, y)+βpen(τ).

In the penalized contrast equation J(τ, y) measures the fit of τ with y and pen(τ) is a penalty term avoids overfitting. The penalty term facilitates controlling the sensitivity of the algorithm when creating segments, and balancing detection from large changes to small changes. The value is further facilitates refocusing detection from small changes in signals, such as EDA, to larger changes in other signals, such as motion signals. β controls the tradeoff between fit and model complexity. In one approach, the implementation further relies on a Bayesian framework that considers possible segmentations and assigns probabilities to each possibility. By way of contrast, a conditional distribution is represented as: p(τ|y; α, β)∝exp{−α(j(τ)+βpen(τ))}.

The correlation system 100 further adds a as a parameter to control an extent of focus on the most probable segmentations. For α, high values make the approach more confident in its best guess, while reducing α allows for more uncertainty and exploration of alternatives, which depends on the unknown parameters α and β that need to be estimated.

$$p ( τ \vert y ; α , β ) = D ( y ; α , β ) {e}^{- a ( j ( τ ) + β p e n ( τ ) )}$$

D(y; α, β) is a normalizing constant. Thus, the task is to find α and β, which may be achieved, in one configuration, according to the following approach.

i. Stochastic approximation of the expectation maximization (SAEM) procedure to estimate α and β. This algorithm iteratively update the estimates of α and β to maximize the likelihood of the observed data under the posterior distribution that is calculated in step ii.

ii. Markov Chain Monte Carlo (MCMC) method to sample from the posterior distribution.

iii. Computing the MAP estimate to minimize the cost function to find the optimal number and time location of τ such as: \hat{τ}=argmin_{τ}(j_{τ}+\hat{β}pen_{τ}). In this way, the correlation system 100 is able to segment the relevant features into separate feature instances, thereby extracting discrete occurrences for subsequent analysis.

At 440, the prediction module 120 determines whether the relevant features have been segmented. As outlined above, the correlation system 100 may define parameters that specify the degree to which the features are segmented. As such, the correlation system 100 may iteratively perform the segmentation until the data is segmented to the extent specified. Thus, at 440, the prediction module 120 may determine whether the segmentation is complete according to the defined parameters. If the segmentation is not complete, then the prediction module 120 iterates over the relevant features again when, for example, new data is acquired. Otherwise, the prediction module 120 continues with identifying the transient discoordination at 450-460.

At 450-460, the prediction module 120 proceeds with identifying the transient discoordination from the segmented feature instances by undertaking multiple separate steps. For example, at 450, the prediction module 120 clusters the feature instances to correlate similar aspects of the relevant features. The prediction module 120 clusters the feature instances into groups according to similarities. In general, the correlation system 100 is maximizing the data similarity within clusters and minimizing similarities across clusters to form the groups. As one example of clustering, consider the following.

In one approach, the correlation system 100 uses dynamic time warping (DTW) to cluster segments. The prediction module 120 compares each segment (i.e., feature instance) with other segments in the time series. Thus, the prediction module 120 may calculate the distance between two feature instances Sₐ, S_{b}∈S, 1≤a, b≤K, that have length of n₁ and n₂, respectively. The prediction module 120 then constructs a matrix Dₙ_{₁}_{×n}_{₂} in which the (i, j) element stores the Euclidean distance between two observations Sₐ(i) and S_{b}(j). Where d_{i,j}=∥Sₐ(i)−S_{b}(j)∥₂. Using the local distance function d, the prediction module 120 finds an optimal dynamic path using dynamic programming. That is, by iteratively evaluating the recurrence formula, the prediction module 120 calculates the cost for each point in a sequence relative to each point in the other. The path with the lowest total cost (i.e., minimum relative cost) represents the optimal alignment between the sequences, as shown by:

$${D}_{i , j} = {d}_{i , j} + min ( {D}_{i - 1 , j} , {D}_{i - 1 , j - 1} , {D}_{i , j - 1} )$$

The equation for D_{i,j} defines the cumulative distance d_{i,j} in the current cell as the sum of the local distance and the minimum cumulative distances of the adjacent cells. After filling all matrix cells, the prediction module 120 defines the warping path Wₚₐₜₕ as a contiguous set of matrix elements that minimizes the overall distance between Sₐ and S_{b}. The total number of elements in the warping path is Q, which serves as a normalizing factor. The warping path satisfies the following attributes: Wₚₐₜₕ=w₁, w₂, . . . w_{Q}; max(n₁, n₂)≤Q≤(n₁, n₂). From the warping paths meeting these conditions, the prediction module 120 seeks the optimal path that minimizes the warping cost, as shown by the following:

$$D T W ( {S}_{a} , {S}_{b} ) = \frac{1}{K} min {\sum }_{q = 1}^{Q} {w}_{q}$$

K normalizes different warping paths with different lengths.

The prediction module 120 then applies a clustering algorithm, such as k-means, hierarchical clustering, or another approach, with the distance matrix to group similar time series together to form two classes: anomaly and non-anomaly. In essence, the correlation system 100 separates the hormonal or metabolic changes that normally happen within the body of a person from changes caused by external events or incidents.

At 460, the prediction module 120 filters anomalies from the feature instances to remove filtered features that are not associated with the transient discoordination and further identifies the transient discoordination. In one arrangement, the prediction module 120 considers the anomalous feature instances together. Due to normal hormonal or metabolic changes, the anomalies can be associated with non-specific responses. Thus, the prediction module 120 can identify event-related responses using, for example, a voting mechanism between different feature instances or, in another approach, by confirming with inputs to the correlation system 100 from outside sources, such as via self-reports or other indicators of stimuli. In any case, the correlation system 100 is able to identify transient discoordination associated with different conditions (e.g., intoxication, fatigue, drowsiness, stroke, heart attack, etc.) within a person.

Additionally, in one configuration, the prediction module 120 calculates a time difference between anomalous segments for each feature instance to form a triangular matrix. The triangular matrix (also referred to as the dynamical interactions matrix) represents the evolving network between organ systems. The prediction module 120 tracks these values to understand the progression of a condition or to detect signs of deterioration. In general, the time difference or delay value from the feature instances corresponds with an onset of the transient discoordination. Moreover, the correlation system 100 may use the delay value as an indication of an intensity of the transient discoordination, which may correlate with an intensity of the condition.

At 470, the prediction module 120 provides an indicator of the transient discoordination when identified in the sensor data 150. As noted previously, the determination of transient discoordination may be indicative of various conditions. Thus, the correlation system 100 can use this indicator about the transient discoordination in combination with ground truth data (e.g., self-reporting of the condition) that identifies a known current condition to form training data. The prediction module 120 can then train a discoordination model (e.g., model 160) using the training data to model a correlation in the sensor data 150 so that the model can then subsequently identify the occurrence from subsequent sensor data.

As implemented, the correlation system 100 can then use the model 160 to identify the conditions associated with the transient discoordination in the particular biosignals. In one approach, the prediction module 120 uses the model 160 to generate indicators 170 of the transient discoordination when detected and as correlated with a particular condition according to the training. The prediction module 120 can then provide the indicator as, for example, a communication to the driver and/or a remote service. For example, the communication to the driver may be an in-vehicle alert that specifies the condition, attempts to remedy the condition (e.g., wake a drowsy driver), and so on. The alert may be a simple indication of a problem or may provide more detailed information, such as specifying to the driver to perform action, such as pull over the vehicle.

The alert may be audio, visual, haptic, etc. Thus, the prediction module 120 may control various systems of the vehicle, such as displays, to provide the alert. In an instance where the prediction module 120 communicates the indicator to a remote service, the communication can be an alert to provide help to the driver. In yet a further embodiment, the prediction module 120 may adapt the operation of the vehicle according to an indicator by, for example, controlling the vehicle to perform an emergency maneuver, such as pullover, slow down, etc. In this way, the correlation system 100 functions to improve the operation of the vehicle by identifying potential negative conditions of the driver and mitigating risks that may be associated with the driver continuing to control the vehicle. While a vehicle related context is described, it should be appreciated that the model 160 may be implemented in further contexts in order to provide information about the current condition of a person being monitored. For example, the model 160 may be implemented in a hospital setting, as part of a personal mobile device, and so on. In this way, the present approach is able to improve the identification of conditions associated with a person and provide a response to facilitate avoiding risks and/or to improve care.

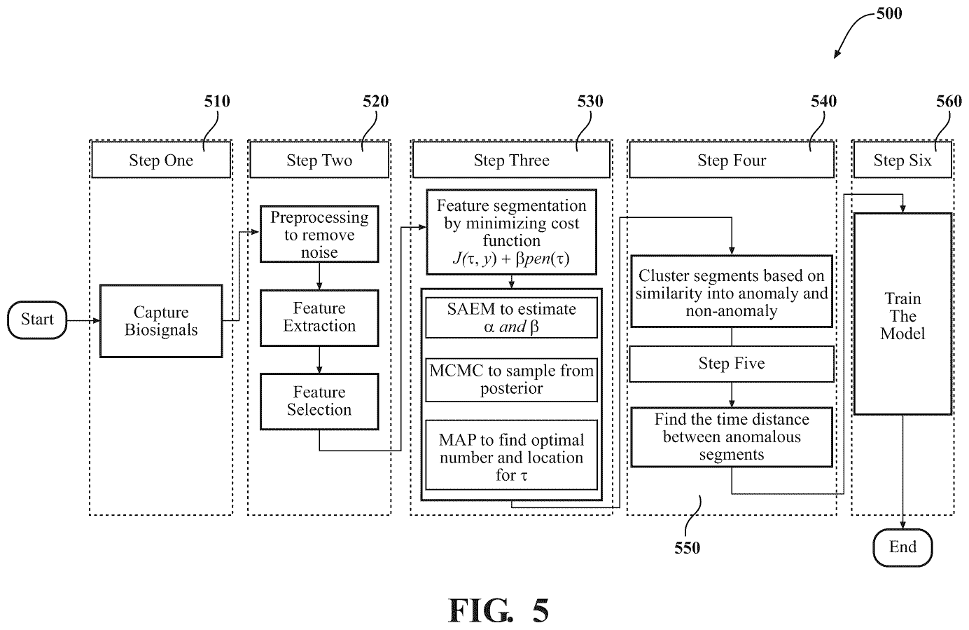

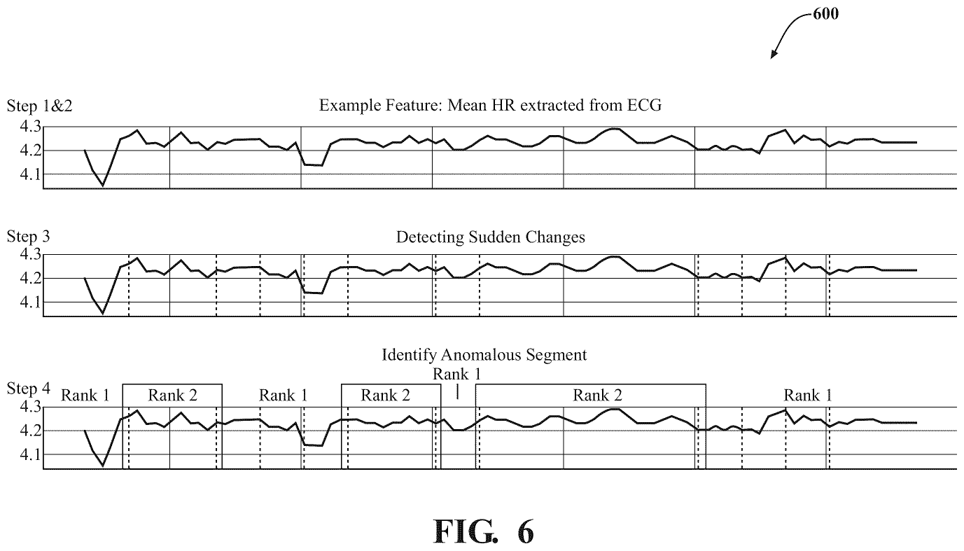

As a further example of how the correlation system 100 identifies transient discoordination, consider FIGS. 5-8. FIG. 5 illustrates an example of an approach 500 implemented by the correlation system to process biosignals into determinations about transient discoordination. As shown in FIG. 5, the approach 500 acquires the biosignals at step 510, which are then fed into step 520. FIG. 6 illustrates one example of a biosignal 600 as processed at separate steps of the approach 500. In particular, the biosignal 600 is an ECG signal as may be acquitted at step 510.

At step 520, as previously described, the approach involves preprocessing the biosignal 600, extracting features, and selecting features. As shown in FIG. 6, the biosignal 600 is processed to extract and select the heart rate from the ECG signal. At step 530, the approach then functions to segment the extracted features into feature instances. As shown in FIG. 6, the biosignal 600 is segmented into multiple different segments of different lengths that correspond with separate heartbeats. At step 540, the approach then identifies anomalous segments via clustering. As shown in FIG. 6, the similarities between the separate segments are considered, and the approach groups the segments into two separate groups (i.e., Rank 1 and Rank 2). In general, a higher rank indicates greater dissimilarity. Thus, the ranks generally indicate the degree of change detected the feature instance relative to the rest of the data.

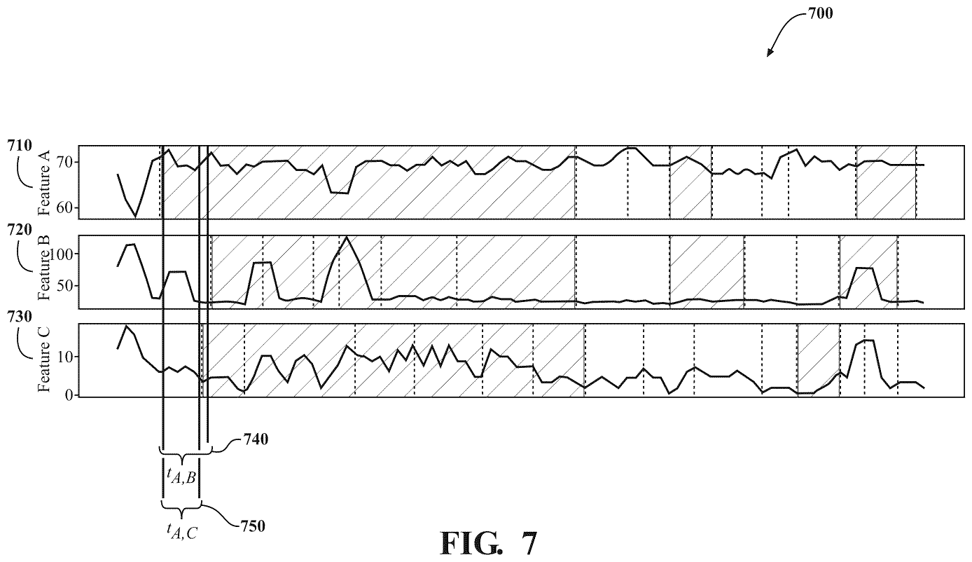

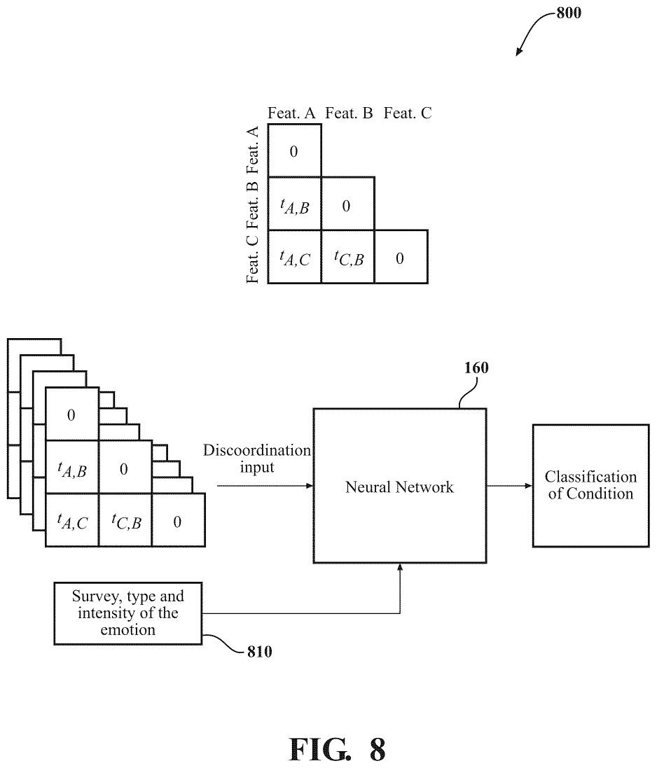

At step 550, the approach filters the anomalies according to the time distance between anomalous segments. For example, with reference to FIG. 7, one example 700 of a comparison between separate features 710, 720, and 730 is shown. In the example 700, the features 710, 720, and 730 are compared via a determination of a comparative delay between the anomalies. As shown, delays 740 and 750 illustrate a portion of this process, which may be iterated over the separate anomalies. The process generates a matrix of values, as shown in FIG. 8 with matrix 800. Multiple of the matrices 800 for the separate features are then provided into the model 160, which functions to, at 560, train the model using the ground truth input 810. In general, the correlation system 100 trains the model 160 using supervised training where the ground truth data is used to compute a loss value according to a loss function.

Detailed embodiments are disclosed herein. However, it is to be understood that the disclosed embodiments are intended only as examples. Therefore, specific structural and functional details disclosed herein are not to be interpreted as limiting but merely as a basis for the claims and as a representative basis for teaching one skilled in the art to variously employ the aspects herein in virtually any appropriately detailed structure. Further, the terms and phrases used herein are not intended to be limiting but rather to provide an understandable description of possible implementations. Various embodiments are shown in FIGS. 1-8, but the embodiments are not limited to the illustrated structure or application.

The flowcharts and block diagrams in the Figures illustrate the architecture, functionality, and operation of possible implementations of systems, methods, and computer program products according to various embodiments. In this regard, each block in the flowcharts or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suited. A typical combination of hardware and software can be a processing system with computer-usable program code that, when being loaded and executed, controls the processing system such that it carries out the methods described herein. The systems, components and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and, which when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. The phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer-readable storage medium would include the following: a portable computer diskette, a hard disk drive (HDD), a solid-state drive (SSD), a read-only memory (ROM), an erasable programmable read-only memory (EPROM or Flash memory), a portable compact disc read-only memory (CD-ROM), a digital versatile disc (DVD), an optical storage device, a magnetic storage device, or any suitable combination of the foregoing. In the context of this document, a computer-readable storage medium may be any tangible medium that can contain, or store a program for use by or in connection with an instruction execution system, apparatus, or device.

Generally, module, as used herein, includes routines, programs, objects, components, data structures, and so on that perform particular tasks or implement particular data types. In further aspects, a memory generally stores the noted modules. The memory associated with a module may be a buffer or cache embedded within a processor, a RAM, a ROM, a flash memory, or another suitable electronic storage medium. In still further aspects, a module as envisioned by the present disclosure is implemented as an application-specific integrated circuit (ASIC), a hardware component of a system on a chip (SoC), as a programmable logic array (PLA), or as another suitable hardware component that is embedded with a defined configuration set (e.g., instructions) for performing the disclosed functions. The term “operatively connected” and “communicatively coupled,” as used throughout this description, can include direct or indirect connections, including connections without direct physical contact.

Program code embodied on a computer-readable medium may be transmitted using any appropriate medium, including but not limited to wireless, wireline, optical fiber, cable, RF, etc., or any suitable combination of the foregoing. Computer program code for carrying out operations for aspects of the present arrangements may be written in any combination of one or more programming languages, including an object-oriented programming language such as Java™, Smalltalk, C++ or the like and conventional procedural programming languages, such as the “C” programming language or similar programming languages. The program code may execute entirely on the user's computer, partly on the user's computer, as a standalone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . and . . . ” as used herein refers to and encompasses any and all possible combinations of one or more of the associated listed items. As an example, the phrase “at least one of A, B, and C” includes A only, B only, C only, or any combination thereof (e.g., AB, AC, BC or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A correlation system, comprising:
one or more processors;
a memory communicably coupled to the one or more processors and storing instructions that, when executed by the one or more processors, cause the one or more processors to:
acquire sensor data that characterizes a current condition of a person;
extract feature instances from the sensor data that correspond with the current condition;
identify transient discoordination in the person according to the feature instances; and
provide an indicator of the transient discoordination.

2. The correlation system of claim 1, wherein the instructions to extract the feature instances include instructions to:
select relevant features from extracted features of the sensor data; and
segment the relevant features into the feature instances that correlate with discrete occurrences within the sensor data.

3. The correlation system of claim 2, wherein the instructions to segment the relevant features into the feature instances function to discretize the relevant features within the sensor data to distinguish between the relevant features in the sensor data that is time-series data.

4. The correlation system of claim 1, wherein the instructions to identify the transient discoordination include instructions to:
cluster the feature instances for relevant features to correlate similar aspects of the relevant features; and
filter anomalies from the feature instances to remove filtered features that are not associated with the transient discoordination.

5. The correlation system of claim 4, wherein the instructions to identify the transient discoordination include instructions to derive a delay value from the feature instances corresponding with an onset of the transient discoordination, the delay value indicating an intensity of the transient discoordination.

6. The correlation system of claim 1, wherein the instructions to provide the indicator of the transient discoordination include instructions to modify operation of a vehicle to alter the current condition of the person.

7. The correlation system of claim 1, wherein the sensor data includes biosignals of the person, and
wherein the transient discoordination indicates at least one of: stress, and drowsiness of the person.

8. The correlation system of claim 1, wherein the instructions to provide an indicator of the transient discoordination include instructions to train a discoordination model using the transient discoordination identified with the sensor data in combination with ground truth data to model a correlation in the sensor data.

9. A non-transitory computer-readable medium including instructions that, when executed by one or more processors, cause the one or more processors to:
acquire sensor data that characterizes a current condition of a person;
extract feature instances from the sensor data that correspond with the current condition;
identify transient discoordination in the person according to the feature instances; and
provide an indicator of the transient discoordination.

10. The non-transitory computer-readable medium of claim 9, wherein the instructions to extract the feature instances include instructions to:
select relevant features from extracted features of the sensor data; and
segment the relevant features into the feature instances that correlate with discrete occurrences within the sensor data.

11. The non-transitory computer-readable medium of claim 10, wherein the instructions to segment the relevant features into the feature instances function to discretize the relevant features within the sensor data to distinguish between the relevant features in the sensor data that is time-series data.

12. The non-transitory computer-readable medium of claim 9, wherein the instructions to identify the transient discoordination include instructions to:
cluster the feature instances for relevant features to correlate similar aspects of the relevant features; and
filter anomalies from the feature instances to remove filtered features that are not associated with the transient discoordination.

13. The non-transitory computer-readable medium of claim 12, wherein the instructions to identify the transient discoordination include instructions to derive a delay value from the feature instances corresponding with an onset of the transient discoordination, the delay value indicating an intensity of the transient discoordination.

14. A method, comprising:
acquiring sensor data that characterizes a current condition of a person;
extracting feature instances from the sensor data that correspond with the current condition;
identifying transient discoordination in the person according to the feature instances; and
providing an indicator of the transient discoordination.

15. The method of claim 14, wherein extracting the feature instances includes:
selecting relevant features from extracted features of the sensor data; and
segmenting the relevant features into the feature instances that correlate with discrete occurrences within the sensor data.

16. The method of claim 15, wherein segmenting the relevant features into the feature instances discretizes the relevant features within the sensor data to distinguish between the relevant features in the sensor data that is time-series data.

17. The method of claim 14, wherein identifying the transient discoordination includes:
clustering the feature instances for relevant features to correlate similar aspects of the relevant features; and
filtering anomalies from the feature instances to remove filtered features that are not associated with the transient discoordination.

18. The method of claim 17, wherein identifying the transient discoordination includes deriving a delay value from the feature instances corresponding with an onset of the transient discoordination, the delay value indicating an intensity of the transient discoordination.

19. The method of claim 14, wherein providing the indicator of the transient discoordination includes modifying operation of a vehicle to alter the current condition of the person,
wherein the sensor data includes biosignals of the person, and
wherein the transient discoordination indicates at least one of: stress, and drowsiness of the person.

20. The method of claim 14, wherein providing an indicator of the transient discoordination includes training a discoordination model using the transient discoordination identified with the sensor data in combination with ground truth data to model a correlation in the sensor data.
